(19) United States
(12) Patent Application Publication
(10) Pub. No.: US 2012/0140274 A1
(43) Pub. Date: Jun. 7, 2012

(54) JOB CONTROL APPARATUS

(75) Inventor: Junichi Miyata, Kawasaki-shi (JP)

(73) Assignee: CANON KABUSHIKI KAISHA, Tokyo (JP)

(21) Appl. No.: 13/305,117

(22) Filed: Nov. 28, 2011

(30) Foreign Application Priority Data
Dec. 7, 2010 (JP) 2010-273016

(51) Int. Cl. G06F 3/12

(52) U.S. Cl. 358/1.15

(57) ABSTRACT

In a case where post-process work instructions are output for respective jobs, the number of work instructions to be managed by a worker increases, resulting in a work efficiency drop. Hence, a job control apparatus of this invention groups jobs having identical post-processes, and integrates post-processes having common settings based on setting information of the grouped post-processes. At the time of execution of job processing, one physical job ticket is issued for each integrated post-process.

### BACKGROUND OF THE INVENTION

1. Field of the Invention

The present invention relates to a job control apparatus in workflow processing.

2. Description of the Related Art

Along with speeding-up and higher image quality of electrophotographic printers and ink-jet printers, a so-called POD (Print On Demand) service competitive with industrial print services is available.

This POD service aims at handling a job having a large number of copies or in large quantities within a short delivery period without using any large-scale apparatuses and systems, and takes full advantage of, for example, a digital image forming apparatus such as a digital copying machine or digital MFP (Multi Function Peripheral). The POD service realizes digital printing using digital data, and management and control using computers is becoming popular compared to the conventional industrial print service.

The POD service generates a workflow including a plurality of processes (for example, a pre-print process, print process, and post-print process) so as to obtain an output result. By advancing processing according to the processes in the workflow, an output result desired by an ordering party is efficiently obtained.

However, as the processing contents executed in the post-print process become complicated, the number of skilled workers who can appropriately execute the post-print process becomes insufficient, and processing of a print job may be delayed. Hence, in order to allow workers who do not have any special skills to execute the post-print process, it is a common practice to print a post-process work instruction which describes finishing processes to be executed by a post-processing machine (to be also referred to as a finisher or finishing machine). When workers handle a larger number of print jobs, many printed matters are output to a discharge unit of an image forming apparatus. For this reason, when the post-process work instruction is simply output, it may be buried in other printed matters.

As a result, each worker has to extract the post-process work instruction buried in the printed matters so as to execute post-processes, and cannot easily find the target post-process work instruction, thus considerably impairing workability and productivity. Since a plurality of post-process work instructions corresponding to a plurality of print jobs are discharged on an output unit, the worker may extract a wrong post-process work instruction from output matters, and may execute post-processes different from those to be originally executed. As a result, the processing cannot be done within the delivery period set by an ordering party, and an output result desired by the ordering party cannot be obtained.

In consideration of such problems, a related art has been proposed to provide an environment which allows a worker to easily extract an appropriate post-process work instruction and to execute output processes which satisfy an output result and delivery period set by an ordering party even in a situation in which many output matters are output onto the discharge unit (for example, see Japanese Patent Laid-Open No. 2008-033659).

In the aforementioned related art, a post-process work instruction is output every time a print job is executed. For this reason, even when a plurality of jobs having the same contents of post-processes are output at similar timings, work instructions are output for respective jobs. For this reason, the number of post-process work instructions to be managed increases, thus causing a work efficiency drop.

### SUMMARY OF THE INVENTION

The present invention has been made in consideration of the above related art, and provides a job control apparatus which can improve work efficiency by reducing the number of work instructions to be managed in a system which executes print processing and post-processing according to a workflow.

According to one aspect of the present invention, there is provided a job control apparatus, which controls execution of jobs for which a plurality of processes including a print process by a printing apparatus and a finishing process by a finishing apparatus are defined by job setting files, the apparatus comprising: a grouping unit, configured to group job data of the respective jobs in correspondence with the same processes as processes included in a job to be processed; an integrating unit, configured to integrate job data of the jobs including common settings in association with a finishing process grouped by the grouping unit; and a sending unit, configured to send job data of the job to be processed to the printing apparatus or the finishing apparatus which performs the processes for respective processes, wherein in a case where the sending unit sends job data to the printing apparatus and prints the job data in a print process of an integrated job, the sending unit issues one physical job ticket for one integrated job for finishing processing of that job.

According to another aspect of the present invention, there is provided a job control apparatus, which is connected to a printing apparatus and a finishing apparatus, and controls execution of jobs for which a plurality of processes including a print process by the printing apparatus and a finishing process by the finishing apparatus are defined by job setting files, the apparatus comprising: a grouping unit, configured to form groups of job setting files and print data of the respective jobs in correspondence with the same processes as processes included in a job to be processed; an integrating unit, configured to integrate job setting files of jobs including common settings of a finishing process in association with a group of the finishing process formed by the grouping unit; and a sending unit, configured to send job data of the job to be processed to the printing apparatus or the finishing apparatus which performs the processes for respective processes, wherein in a case where the sending unit sends job data associated with the job setting file integrated by the integrating unit to the printing apparatus in the print process, the sending unit sends one physical job ticket for one integrated job to the printing apparatus together, and controls the printing apparatus to print the physical job ticket.

According to the present invention, the number of work instructions to be managed is reduced in a system which executes print processing and post-processing according to a workflow, thereby improving work efficiency.

Further features of the present invention will become apparent from the following description of exemplary embodiments with reference to the attached drawings.

### BRIEF DESCRIPTION OF THE DRAWINGS

FIG. 1 is a block diagram of the entire system according to the present invention;

FIG. 2 is a diagram showing details of processes of the system shown in FIG. 1;

FIG. 3 is a block diagram showing the hardware arrangement according to the present invention;

FIG. 4 is a block diagram showing the structure of a program according to the present invention;

FIG. 5 is a view for explaining components of a product according to an embodiment of the present invention;

FIG. 6 is a view for explaining printed matters of a wraparound band and cover according to the embodiment;

FIG. 7 is a view for explaining the sequence of processes according to the embodiment;

FIG. 8 is a view showing the structure of all processing data according to the embodiment;

FIG. 9 is a table for exemplifying the structure of a job setting file according to the embodiment;

FIG. 10 is a view for explaining the structure of a job ticket template according to the embodiment;

FIG. 11 is a view for exemplifying a job ticket template associated with a wraparound band according to the embodiment;

FIG. 12 is a view for exemplifying a job ticket template associated with a cover according to the embodiment;

FIG. 13 is a view for exemplifying a job ticket template associated with an in-cover according to the embodiment;

FIG. 14 is a flowchart of a finisher control program according to the present invention;

FIG. 15 is a flowchart showing details of step S1401 in FIG. 14;

FIG. 16 is a flowchart showing details of step S1402 in FIG. 14;

FIG. 17 is a flowchart showing details of step S1403 in FIG. 14;

FIG. 18 is a view for exemplifying all job data rearranged for respective processes according to the embodiment;

FIG. 19 is a view for exemplifying all job data which are rearranged for respective processes and also for respective job settings according to the embodiment;

FIG. 20 is a view for exemplifying a physical job ticket associated with a cover according to the embodiment;

FIG. 21 is a view for exemplifying another physical job ticket associated with a cover according to the embodiment;

FIG. 22 is a view for exemplifying a physical job ticket associated with an in-cover according to the embodiment;

FIGS. 23 and 24 are tables for exemplifying job setting files according to the embodiment; and

FIG. 25 is a view for exemplifying all job data according to the embodiment.

### DESCRIPTION OF THE EMBODIMENTS

### First Embodiment

<Arrangement of Bookbinding System>

The best mode of carrying out a bookbinding system according to this embodiment will be described below with reference to the drawings. This bookbinding system can also be called a workflow processing system which controls a workflow configured by connecting a plurality of processes in series or in parallel, including, for example, a print process and finishing process. In the workflow processing system, an information processing apparatus (to be described later) serves as a workflow control apparatus to control and manage execution of a workflow including a manual process. Note that the defined workflow including a series of processes is also called a job. For this reason, the workflow control apparatus is also called a job control apparatus.

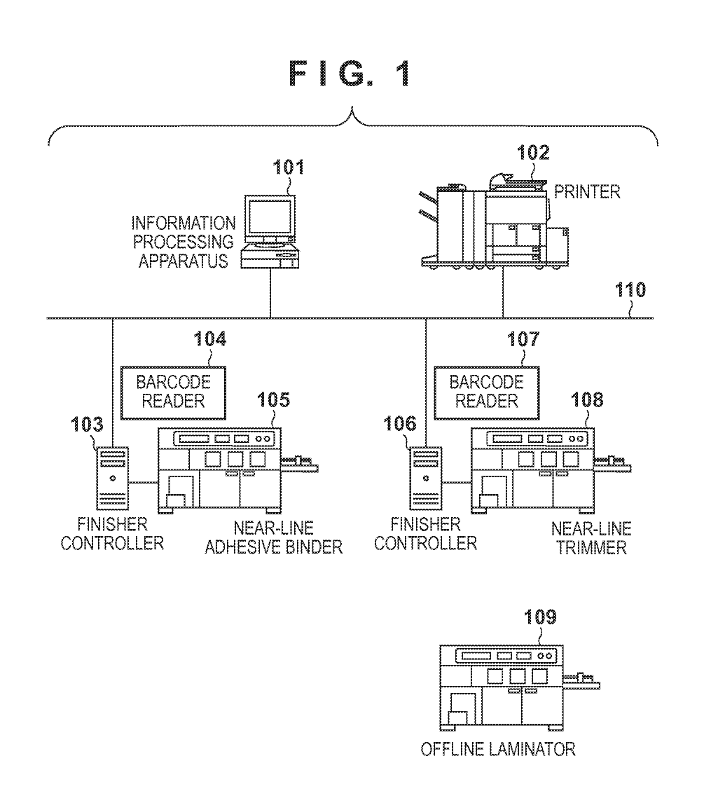

FIG. 1 shows an example of the arrangement of a system for creating an adhesive-bound book product according to the present invention. This system has an arrangement in which an information processing apparatus 101, printer 102, near-line adhesive binder 105 as a post-processing apparatus, and near-line trimmer 108 as a post-processing apparatus are connected via a network 110. The printer and post-processing apparatuses which execute a job will often be simply referred to as peripheral devices. Furthermore, to the near-line adhesive binder 105, a finisher controller 103 which controls the near-line adhesive binder 105, and a barcode reader 104 which operates on the near-line adhesive binder 105 are respectively connected. The near-line adhesive binder 105 may be connected to the network via the finisher controller 103. An operator makes a predetermined operation on, for example, an operation panel of the near-line adhesive binder 105 to control the near-line adhesive binder 105 to read a barcode via the barcode reader 104. To the near-line trimmer 108, a finisher controller 106 which controls the near-line trimmer 108, and a barcode reader 107 which operates on the near-line trimmer 108 are respectively connected. The near-line trimmer 108 may be connected to the network via the finisher controller 106. Furthermore, an offline laminator 109 as a post-processing apparatus which is not connected to the network 110 is also included in the system. Note that a near-line finisher such as the near-line adhesive binder means a finisher, which is connected to the printer 102 and can exchange data and the like with the printer 102, but on which objects to be processed (for example, output matters of the printer) have to be manually set.

Note that a barcode is used to correctly input a job ID. In place of displaying and reading a barcode, a job ID may be displayed using normal numerals and letters, and may be input from, for example, a keyboard by an operator.

<Bookbinding Processing>

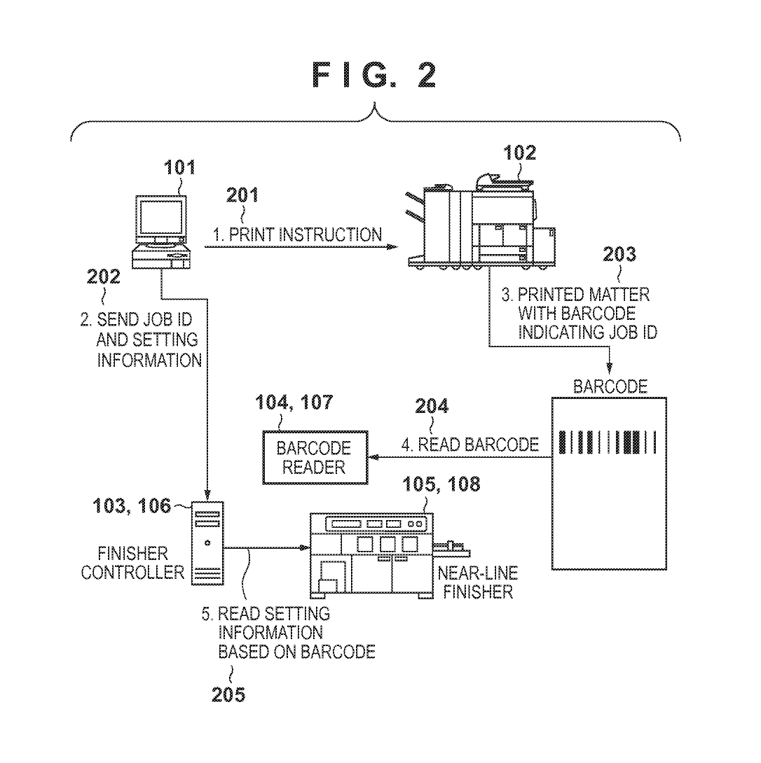

FIG. 2 exemplifies a sequence of bookbinding processes by the information processing apparatus 101, printer 102, finisher controller 103, barcode reader 104, and near-line adhesive binder 105 shown in FIG. 1. Note that FIG. 2 will explain processing associated with the finisher controller 103, barcode reader 104, and near-line adhesive binder 105, but the same applies to a description of a sequence of processes of the finisher controller 106, barcode reader 107, and near-line trimmer 108. FIG. 2 illustrates the near-line adhesive binder 105 and near-line trimmer 108 together as a near-line finisher.

Referring to FIG. 2, the information processing apparatus 101 issues a print instruction to the printer 102 (201). The print instruction sent to the printer 102 includes a print job, which includes data to be printed (print data) and a job ticket required to specify print settings and the like. Next, the information processing apparatus 101 sends, to the finisher controller 103, finisher setting information and a job ID required to operate the near-line adhesive binder 105 (202). The job ID is an ID required to specify the print job sent to the printer 102, and is unique to a job in the bookbinding system. The finisher setting information is stored in the finisher controller 103 in association with the job ID which is sent at the same time.

As a first page of printed matters output from the printer 102, a physical job ticket sheet which describes the job ID sent to the finisher controller in step 202 as a barcode is output (printed) (203). A worker who generates an adhesive-bound book product carries the physical job ticket and printed matters output in step 203 to the near-line adhesive binder 105, and reads the barcode (indicating the job ID) of the physical job ticket using the barcode reader 104 (204). The near-line adhesive binder 105 searches stored job IDs for the job ID read from the barcode reader. If the corresponding job ID is found, the near-line adhesive binder 105 reads out (that is, loads) finishing settings stored in association with that job ID onto a memory or the like as those of the job to be processed. Finishing processing is executed according to the corresponding finishing settings.

<Hardware Arrangement of Information Processing Apparatus 101>

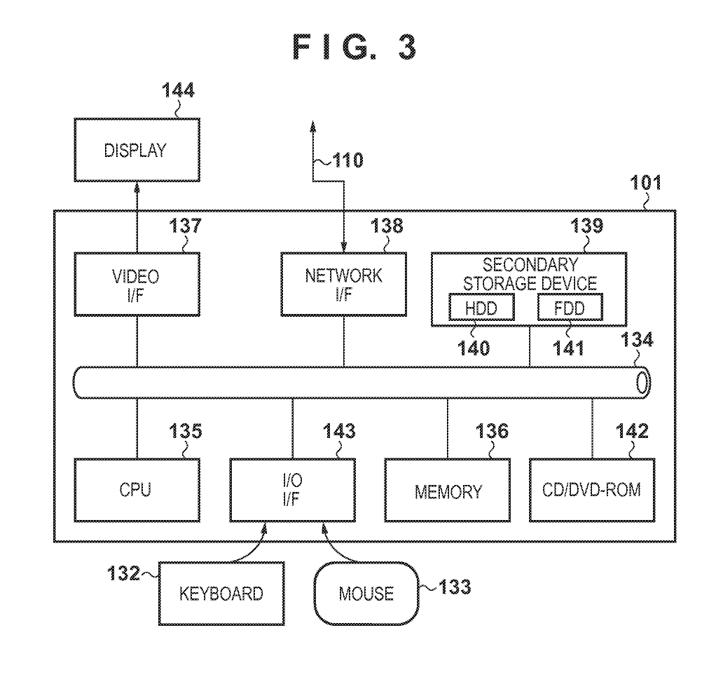

FIG. 3 exemplifies the hardware arrangement of the information processing apparatus 101 according to the present invention. To the information processing apparatus 101, input devices including a keyboard 132 and a pointing device such as a mouse 133 are connected, and a display 144 is also connected. A network interface 138 can connect the information processing apparatus 101 to the network 110 to connect it to another computer and near-line finisher in the system. The network 110 typically includes a LAN (Local Area Network) or WAN (Wide Area Network). The information processing apparatus 101 includes the following typical components:
ea processor unit (CPU) 135;
a memory unit 136 including a RAM (Random Access Memory) and ROM (Read Only Memory);
an I/O interface including a video interface 137; and
an I/O interface 143 for the keyboard 132 and mouse 133.

A secondary storage device 139 typically includes a hard disk drive (HDD) 140 and flexible disk drive 141. Although not shown, the secondary storage device 139 may also include a magnetic tape drive. A CD-ROM drive 142 is provided as a nonvolatile data source. A finisher control program which implements the sequences shown in the flowcharts of the present invention (to be described later) is stored in readable media including the aforementioned storage devices. The program is loaded from a computer-readable medium, and is executed by the CPU 135 of the information processing apparatus 101.

<Finisher Control Program>

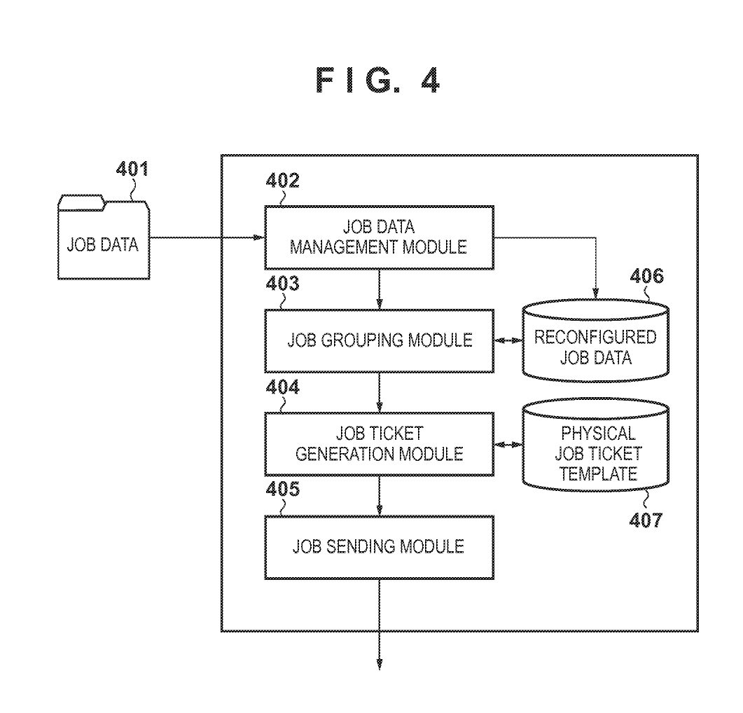

FIG. 4 exemplifies the software module arrangement of a finisher control program according to this embodiment. Referring to FIG. 4, job data 401 indicates all job data to be processed in this embodiment. Note that the job data includes data of respective components which are to undergo bookbinding processing, and job setting files which define a workflow in the bookbinding system. A job data management module 402 loads the job data 401, and manages the data. A job grouping module 403 reconfigures all the job data loaded by the job management module to internal data according to the present invention. A job ticket generation module 404 generates physical job tickets from all the job data reconfigured by the job grouping module 403. A physical job ticket is a job ticket output as a printed matter. A job sending module 405 sends job data to the printer 102 and finisher controllers 103 and 106. A reconfigured job data storage area 406 stores all the job data reconfigured by the job grouping module 403. A physical job ticket template storage area 407 stores data templates of physical job tickets to be output to the printer 102.

<Configuration of Book>

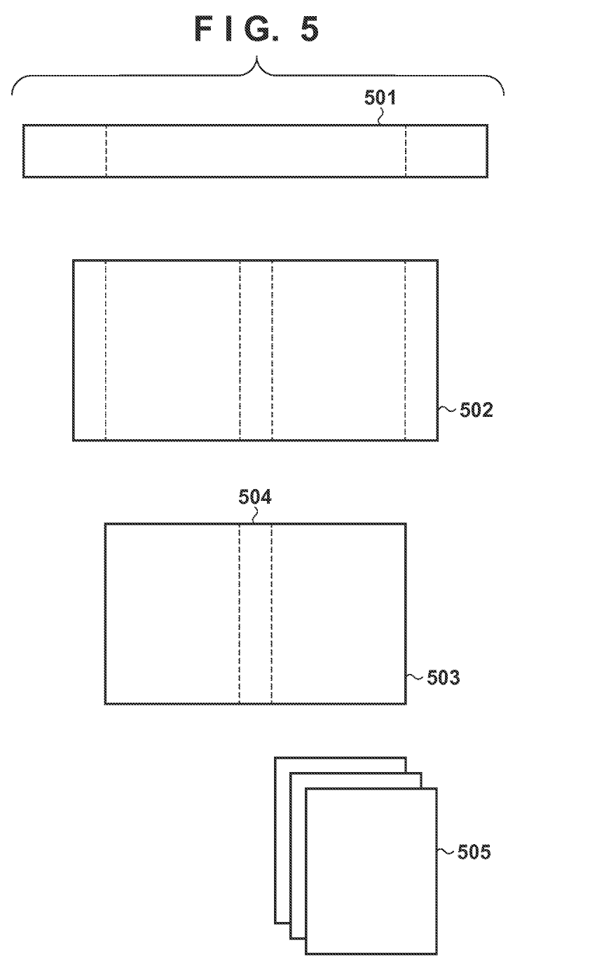

FIG. 5 exemplifies respective components which configure an adhesive-bound product (that is, book) according to this embodiment. A wraparound band 501 indicates that to be attached to the adhesive-bound product. A cover 502 indicates that to be attached to the adhesive-bound product. An in-cover 503 indicates that of the adhesive-bound product. Reference numeral 504 denotes a region of the spine of the adhesive-bound product. A body 505 indicates that as the entire body text of the adhesive-bound product.

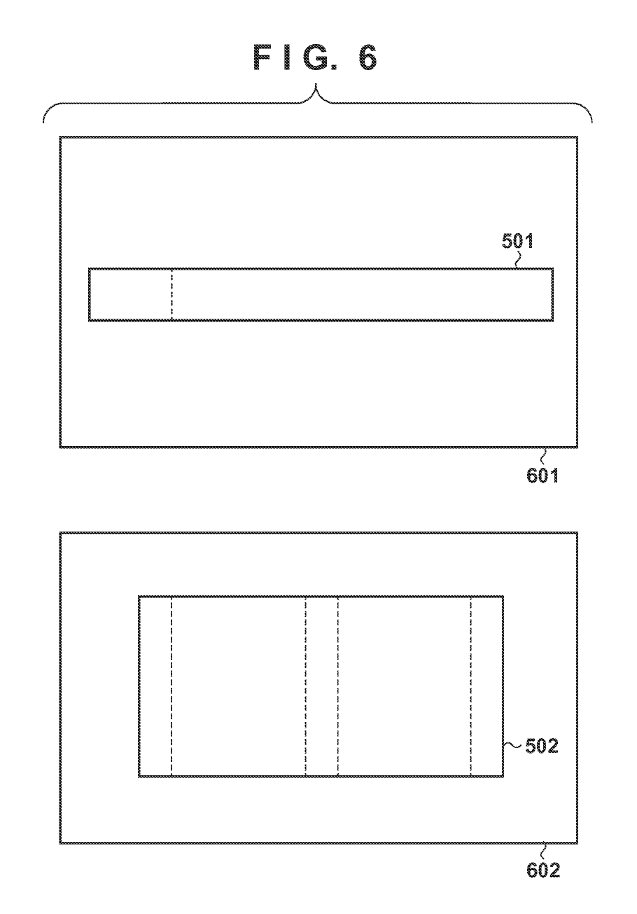

FIG. 6 shows print data of the wraparound band and cover output from the printer 102. A paper sheet 601 indicates that output from the printer 102. The wraparound band 501 is a layout region of wraparound band data to be actually used. That is, in this embodiment, on a paper sheet output from the printer 102, an image of a wraparound band to be actually used is laid out inside the paper sheet, and the paper sheet is trimmed along the wraparound band layout region to use it as the wraparound band. The wraparound band data layout region will be described as a trimming rectangle hereinafter.

A paper sheet 602 indicates that output from the printer 102. The cover 502 is a layout region of cover data to be actually used. That is, in this embodiment, on a paper sheet output from the printer 102, a cover to be actually used is laid out inside the paper sheet, and the paper sheet is trimmed along the cover layout region to use it as the cover. The cover data layout region will be described as a trimming rectangle hereinafter.

<Example of Workflow>

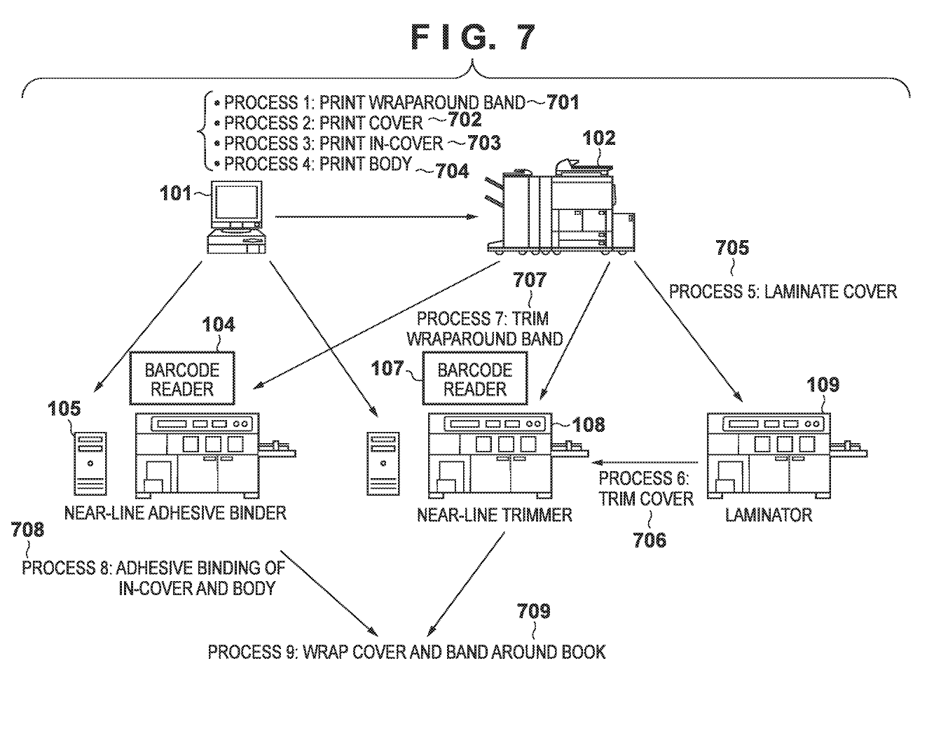

FIG. 7 exemplifies a workflow including the information processing apparatus 101, printer 102, near-line adhesive binder 105, near-line trimmer 108, and offline laminator 109 according to this embodiment, and shows the sequence of processes until an adhesive-bound product is completed.

In process 1, wraparound band data is sent from the information processing apparatus 101 to the printer 102, which prints a wraparound band (701). In process 2, cover data is sent from the information processing apparatus 101 to the printer 102, which prints a cover (702). In process 3, in-cover data is sent from the information processing apparatus 101 to the printer 102, which prints an in-cover (703). In process 4, body data is sent from the information processing apparatus 101 to the printer 102, which prints a body (704). The body indicates a body text portion of a book except for the cover and in-cover. In process 5, the cover data printed in process 2 is laminated by the offline laminator 109 (705). In process 6, the laminated cover data in process 5 is trimmed along the trimming rectangle 502 by the near-line trimmer.

In process 7, the wraparound band printed in process 1 is trimmed along the trimming rectangle 501 by the near-line trimmer. In process 8, the near-line adhesive binder applies an adhesive binding process to the in-cover data and body data printed in processes 3 and 4.

In process 9, the adhesive-bound product is completed by combining an adhesive-bound product generated in process 8, a wraparound band product generated in process 7, and a cover product generated in process 6.

<Example of Job Data>

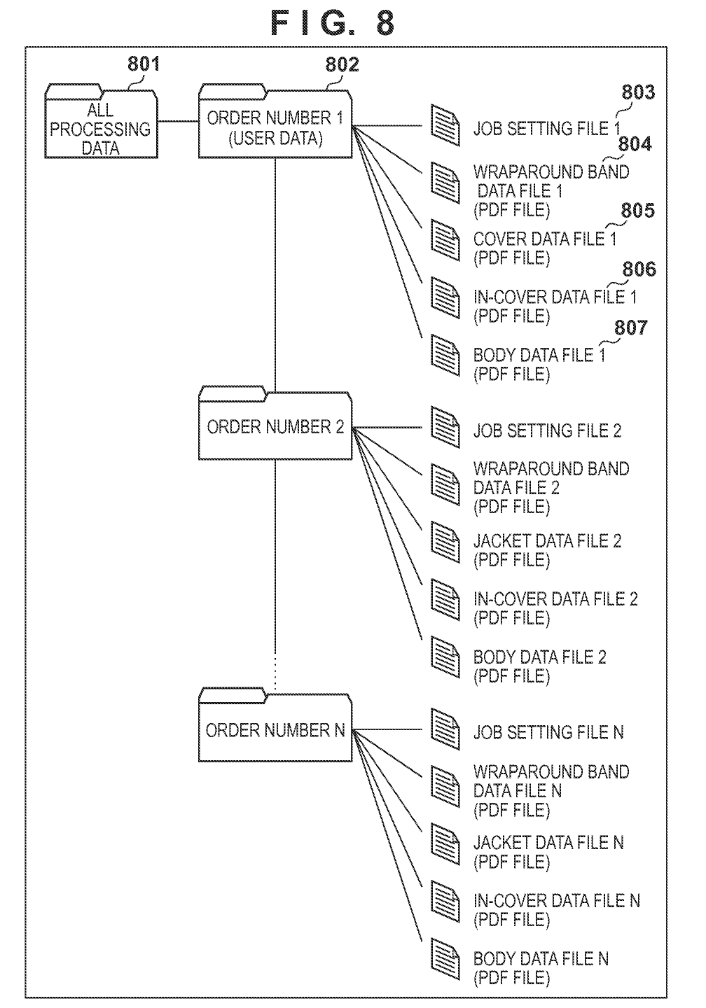

FIG. 8 illustrates the structure of all the job data 401. In this embodiment, assume that the job data are created in advance. That is, data of components (component data) required for bookbinding are created by, for example, an ordering party using a page description language such as PDF, and are combined with job setting files indicating how to apply print processes, trimming processes, and the like to these components in the bookbinding system to configure one job data. A root folder 801 indicates that of all the job data. Sub folders 802 are those for respective user data. User data is job data for each user. In this embodiment, different job data of an identical user are handled as different user data. Note that this embodiment is premised on that products are created respectively from a plurality of job data, and the respective sub folders 802 correspond to the job data of the respective users. Hence, especially, each sub folder 802 will often be called a user folder. A job setting file 803 and component data files 804 to 807 as entities of the job data belong to each sub folder 802.

The job setting file 803 describes job settings desired by the user. A wraparound band data file 804 indicates contents of a wraparound band to be printed. A cover data file 805 indicates contents of a cover to be printed. An in-cover data file 806 indicates contents of an in-cover to be printed. A body data file 807 indicates contents of a body to be printed. Note that each job data includes as many folders as the number of jobs, as shown in FIG. 8. Also, each data file is described using PDF in this example, but other languages may be used, as a matter of course.

<Example of Job Setting File>

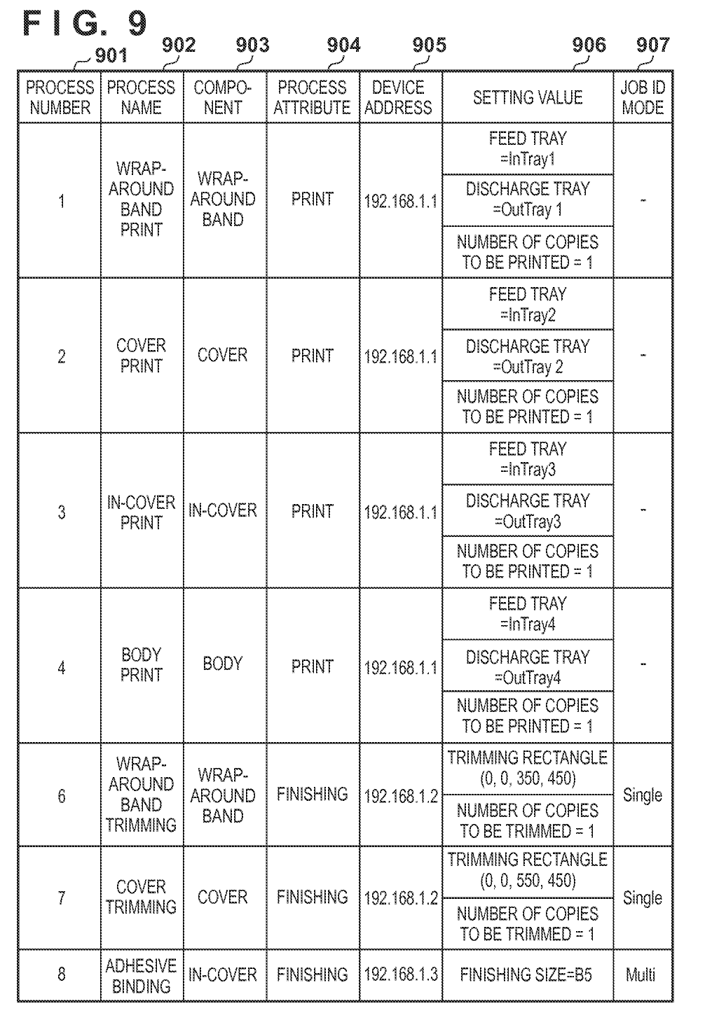

FIG. 9 exemplifies the job setting file 803. The job setting file 803 is data indicating a workflow, which is completed, for example, when an operator gives parameters to templates each of which includes respective fields in advance.

Referring to FIG. 9, a process number 901 and process name 902 indicate the process numbers and process names of respective processes required to produce products of each user data, and correspond to the respective processes shown in FIG. 7. Note that FIG. 9 does not describe processes 5 and 8 in which the finisher control program does not execute any electronic control. Processes in which the finisher control programs executes electronic control are those using the printer 102 or near-line finisher 105 or 108, and the remaining processes are those in which the finisher control program does not execute any electronic control.

A component column 903 includes fields that store the names of the respective parts (to be referred to as components hereinafter) such as a wraparound band, cover, in-cover, and body, which configure an adhesive-bound product, and the printer 102 outputs physical job tickets in correspondence with the components of these fields. A process attribute 904 stores information indicating a print process or finishing process. A device address 905 is an address of a printer or post-processing apparatus, and each job is sent to this address.

A setting value 906 includes fields that store setting values (parameters) of jobs of the respective processes. For example, in case of a print process, feed tray, discharge tray, and the number of copies are given as setting values. In case of a trimming process, the position and size of a trimming rectangle (for example, the coordinates of corner points of a rectangle), and the number of copies to be trimmed are given as setting values. Also, in case of a binding process, a finishing size is given as a setting value. In the print process, a data file name (for example, “body_data_file_{—}1.pdf”) required to specify a data file to be printed may be registered in the job setting file. In this way, the data file to be printed can be explicitly associated with the process. Of course, a method of appending component names to file names or sorting files in an order of processes can also represent associations between the processes and data files. In any case, the data files and processes are associated with each other, and these associations can be loaded in the bookbinding processes. A job ID mode 907 includes fields that store job ID modes (to be described later), and the number of job IDs to be issued is controlled in accordance with the job ID mode. In the job ID mode 907, one of two values “Multi” and “Single” or no value is set. “Multi” indicates that the corresponding processes are independently executed for respective user data. “Single” indicates that the corresponding processes are integrated into one if they include common parameters.

Referring to FIG. 9, in a process number 1 (“wraparound band print” process), an address “192.168.1.1” of the printer 102 is designated as a device address. Also, the settings of this process instruct that paper sheets are fed from “InTray1” as a feed tray, and are discharged onto “OutTray1” as a discharge tray.

<Physical Job Ticket>

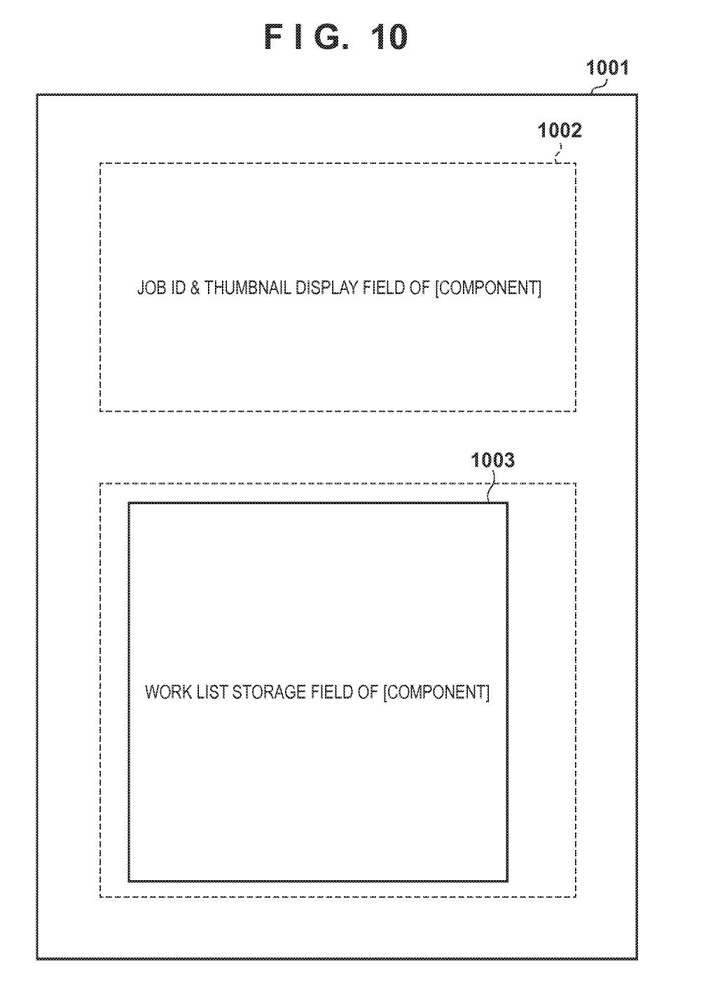

FIG. 10 is a view for explaining the structure of a template file as source data of a work instruction (to be referred to as a physical job ticket hereinafter) output from the printer for each component 903. The template is stored in advance in the physical job ticket template storage area 407. A template 1001 indicates the overall job ticket template. A job ID field 1002 displays a job ID and thumbnail of each component, as will be described later. The job ID is displayed as a barcode in this embodiment. A work explanation field 1003 describes work explanations in a process required for a worker to process a corresponding component.

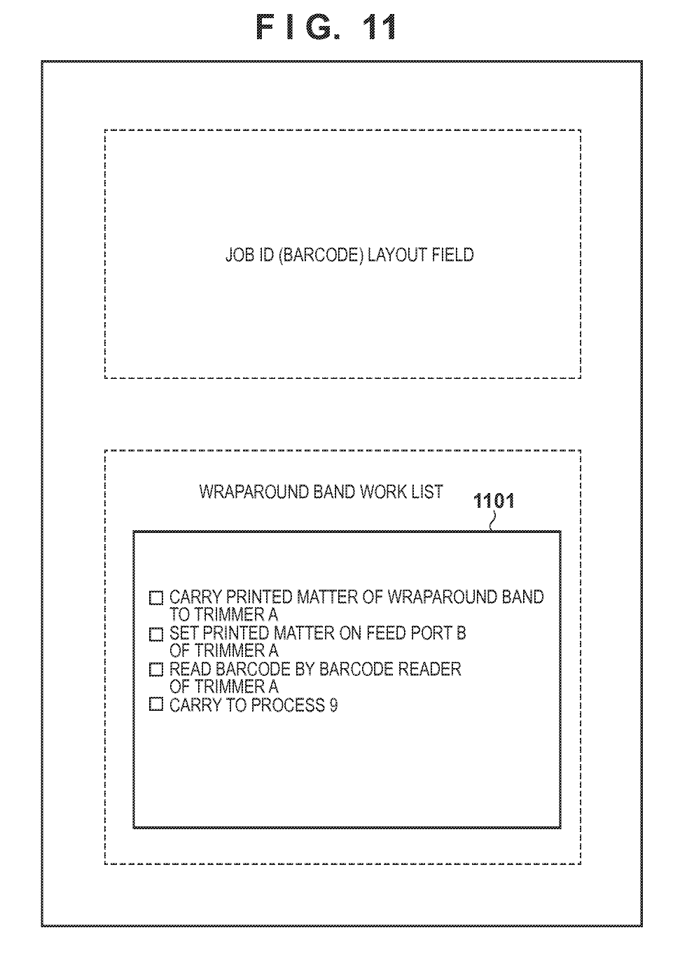

FIGS. 11, 12, and 13 show examples of templates for respective components of the physical job ticket shown in FIG. 10. FIG. 11 shows a physical job ticket template when the component is wraparound band. A work explanation field 1101 describes explanations about the process for processing the wraparound band. The work explanations of the process correspond to instructions for an operator, and are determined in advance in accordance with the functions of the printer and finisher used to execute this process. For example, as for “wraparound band”, work instructions “carry printed matter of wraparound band to trimmer A”, “set printed matter on feed port of trimmer A”, “read barcode by barcode reader of trimmer A”, and “carry to process 9” are included. In this case, “trimmer A”, “process 9”, and the like can be rewritten as needed according to a workflow to be processed. Of course, in a job ID field, a barcode according to a job ID is displayed. Also, a template itself is changed according to the configuration of the bookbinding system and functions of the respective devices.

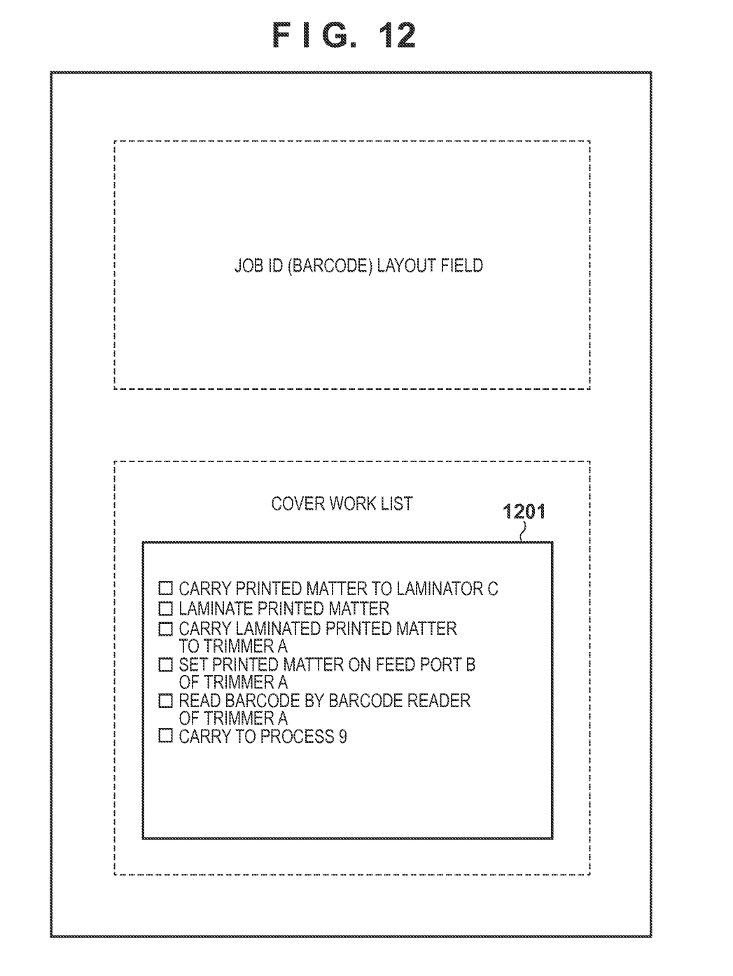

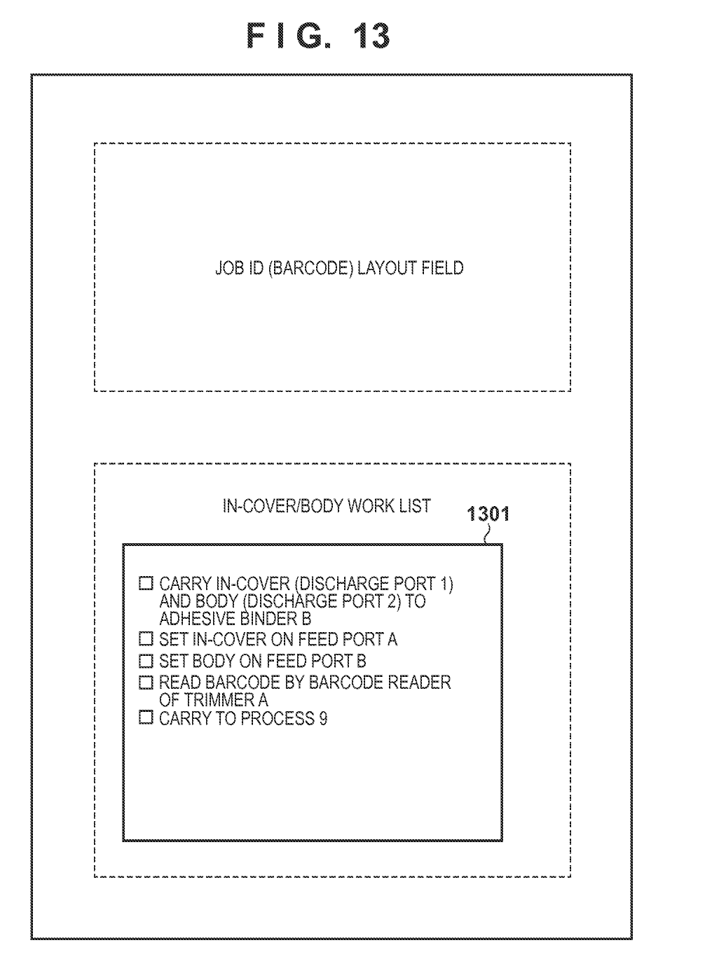

FIG. 12 shows a physical job ticket template when the component is a cover. A work explanation field 1201 describes explanations about the process for processing a cover. FIG. 13 shows a physical job ticket template when the component is an in-cover. A work explanation field 1301 describes explanations about the process for processing a body and in-cover. The templates shown in FIGS. 12 and 13 also describe work instructions for the operator as in FIG. 11. In this case, the in-cover/body physical job ticket template shown in FIG. 13 is to be noticed. This template is that of the physical job ticket issued for two components, that is, an in-cover and body. Since the in-cover and body are bound together, and since it is rational to combine their processes into one physical job ticket, one physical job ticket is issued for these two components. The work explanation field 1301 describes works for the in-cover and body, respectively. FIG. 13 describes work instructions “carry in-cover (discharge port 1) and body (discharge port 2) to adhesive binder B”, “set in-cover on feed port A”, “set body on feed port B”, “read barcode by barcode reader of trimmer A”, and “carry to process 9”.

<Finisher Control Sequence>

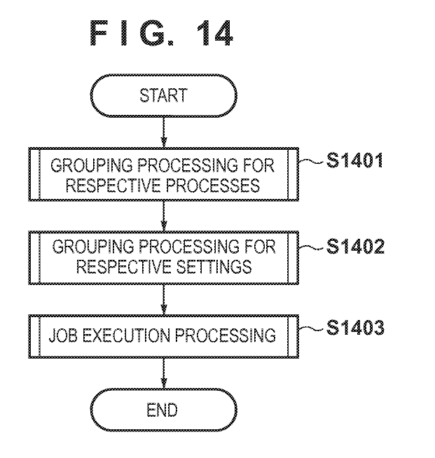

FIG. 14 shows an overview of a flowchart of the finisher control program according to the present invention. Note that the finisher control program which implements the sequence shown in this flowchart is stored in the storage device 139 of the information processing apparatus 101 or is loaded from a computer-readable recording medium, and is executed by the CPU 135.

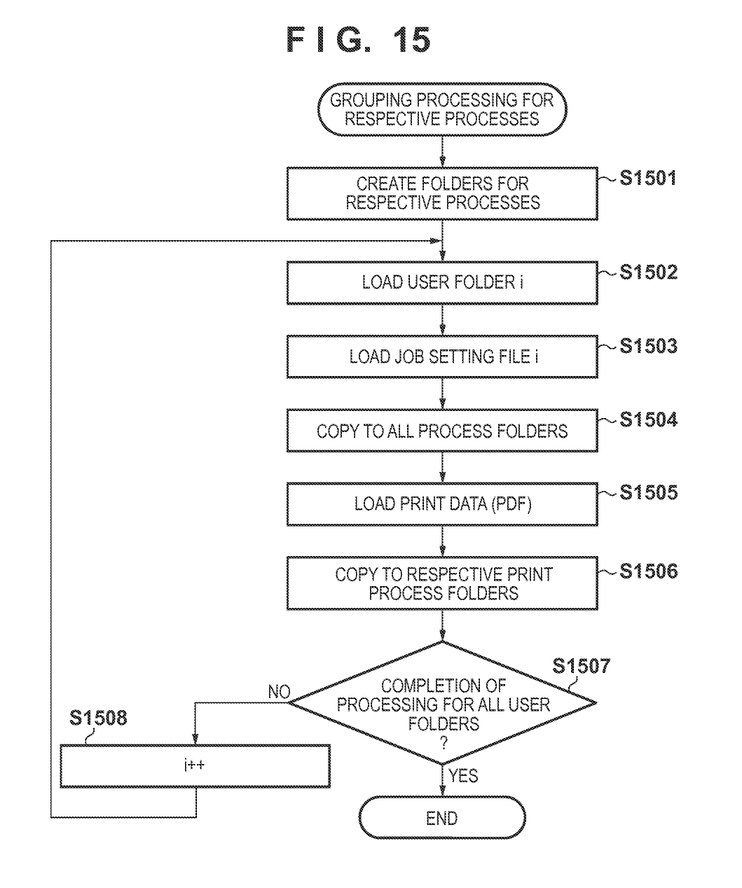

The finisher control program (mainly executed by the CPU) groups all the job data shown in FIG. 8 for respective processes to reconfigure the entire job data in step S1401. As described above using FIG. 9, data files and processes are associated with each other, and the data files can be grouped according to these associations. Note that details of the processing in step S1401 will be described later using the flowchart shown in FIG. 15.

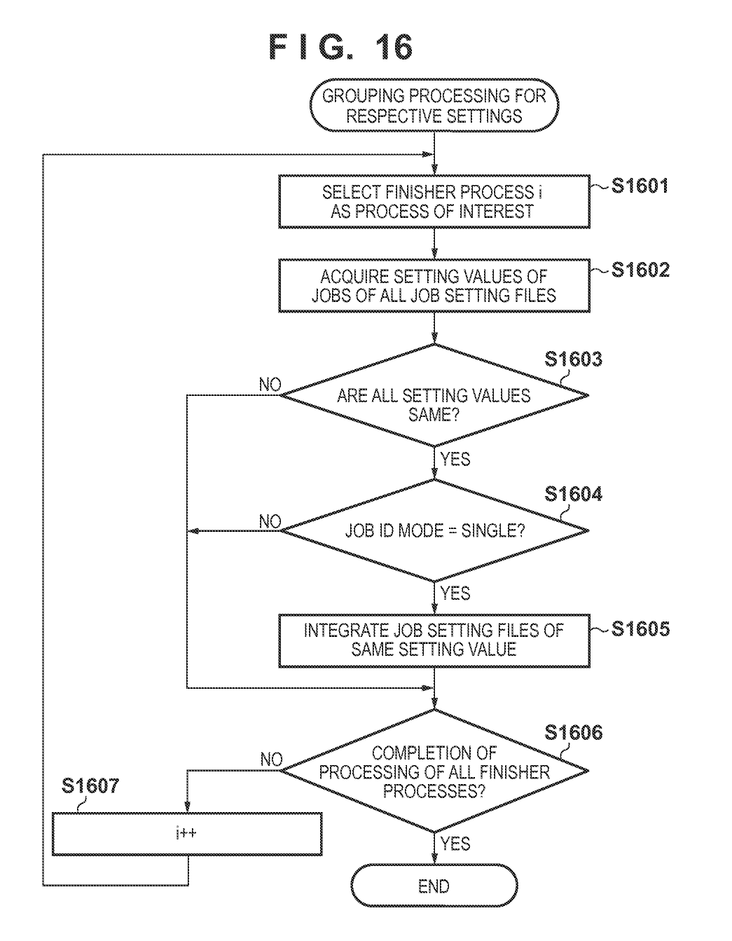

In step S1402, the job data grouped for the respective processes in step S1401 are further reconfigured for the respective settings described in the job setting files. In this reconfiguring step, if a finishing process of interest includes jobs having common settings of that process, the jobs are integrated. Note that details of the processing in step S1402 will be described later using the flowchart shown in FIG. 16.

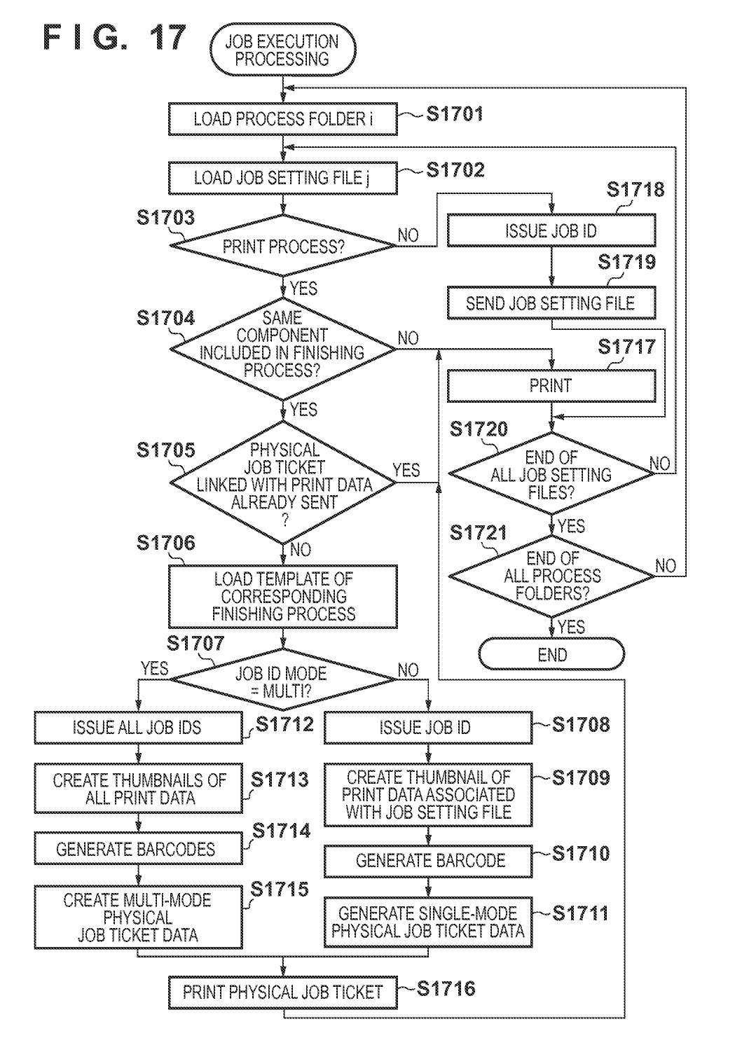

In step S1403, jobs are executed for all the job data reconfigured in step S1402. Details of the job execution processing in step S1403 will be described later using the flowchart shown in FIG. 17.

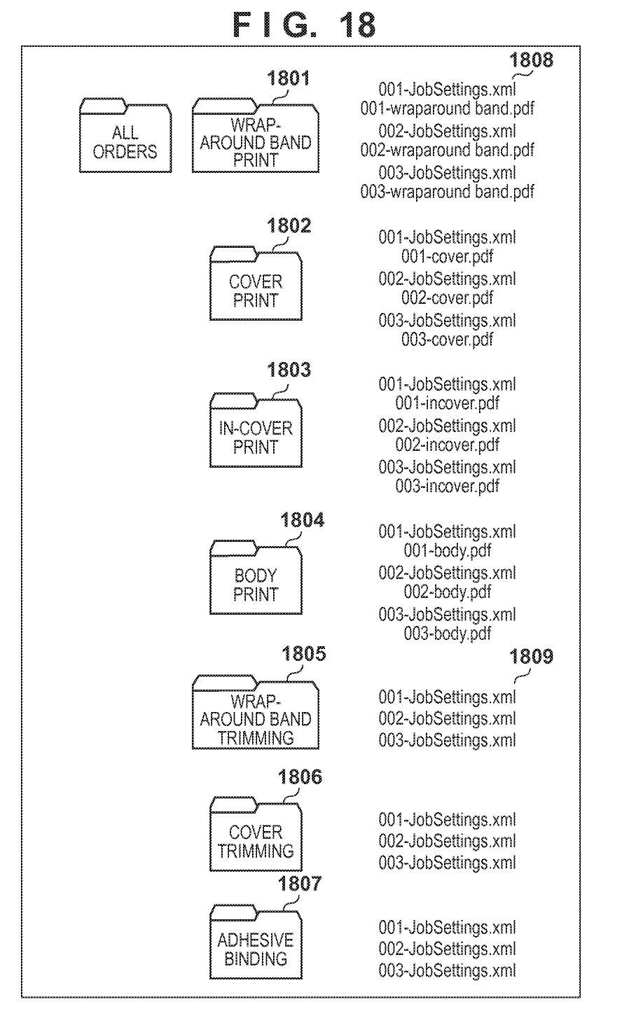

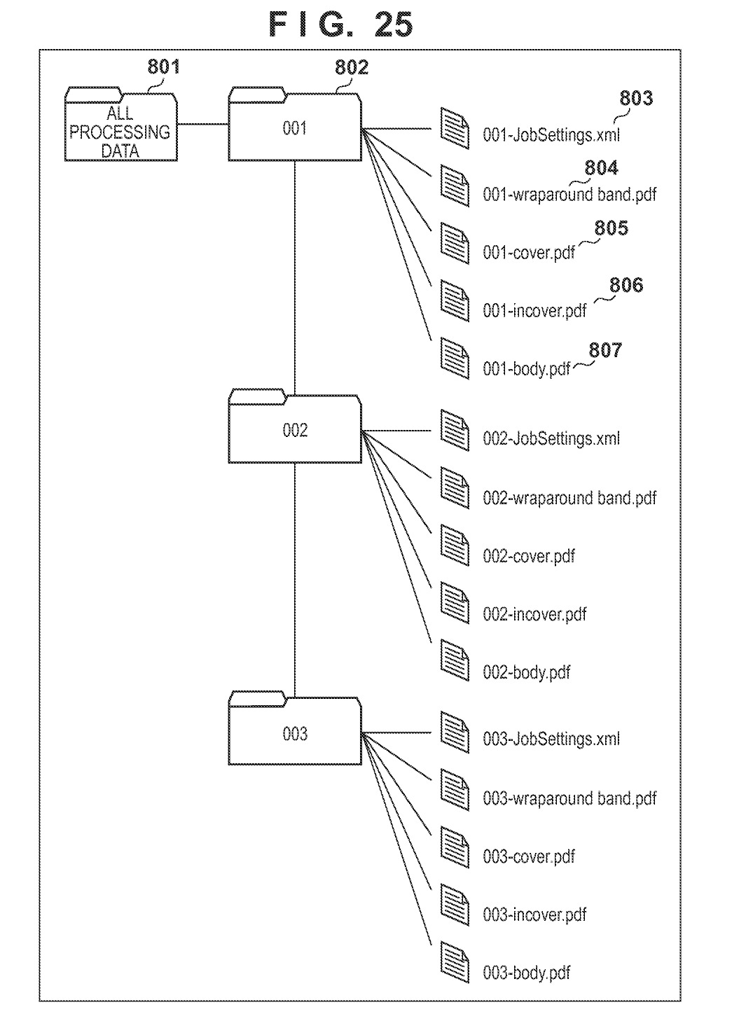

In this embodiment, as for job data to be processed, FIG. 25 shows an example that describes practical file names under the assumption that the number N of user folders 802 in FIG. 8 is 3. FIG. 18 shows job data reconfigured as a result of the flowchart shown in FIG. 15.

Step S1401 will be described below. Referring to FIG. 15, the job data management module 402 of the finisher control program creates folders for respective processes for a workflow to be processed in step S1501. This folder configuration includes folders 1801 to 1807. That is, in the workflow of this example, of the nine processes shown in FIG. 7, the processes except for process 5 using the offline laminator 109 and process 9 in which a worker wraps the cover and wraparound band around the bound body and in-cover to obtain a final product are computerized. Hence, folders are respectively created for these seven processes. The number of computerized processes can be detected with reference to, for example, the job setting file 803 shown in FIG. 9. Of course, a folder to be created is, for example, a digital folder which configures a node of a hierarchical management structure of computer files like that of a Windows® OS. Note that folder names of the folders 1801 to 1807 shown in FIG. 18 correspond to those in the process name 902 shown in FIG. 9. Therefore, the folder names can be obtained by copying the process names of the job setting file 803 for the respective processes.

Next, the grouping module 403 sequentially loads the user folders 802 (S1502), and copies the job setting files of the respective user folders into the respective process folders (S1503 and S1504). That is, the job setting files of all the user folders are copied to the process folders. In this case, for a process associated with a folder to be copied and a process having the same component name as that of the former folder, it suffices to copy all attributes, that is, the process number 901 to job ID mode 907, but in this embodiment, the entire job setting file is copied.

Furthermore, print data 804, 805, 806, and 807 in the user folders are loaded in step S1505, and are copied to the folders 1801, 1802, 1803, and 1804 of the print processes corresponding to the respective print data in step S1506. More specifically, wraparound band data files of all the user folders are copied to the wraparound band print process folder, and cover data files of all the user folders are copied to the cover print process folder. Also, in-cover data files of all the user folders are copied to the in-cover print process folder, and body data files of all the user folders are copied to the body print process folder.

This processing is executed for all the user folders 802. It is checked in step S1507 if the processing is complete for all the folders. If YES in step S1507, the processing ends. If folders to be processed still remain, the next user folder is selected as a user folder of interest (S1508), and the process returns to step S1502. Upon completion of this processing, folder information is as shown in FIG. 18.

FIG. 18 shows job data obtained by rearranging all the processing data shown in FIG. 25 in the folders 1801 to 1807 for the respective processes by the sequence shown in FIG. 15. Also, as shown in data files 1808 and 1809, user data shown in FIG. 25 are arranged for the respective processes.

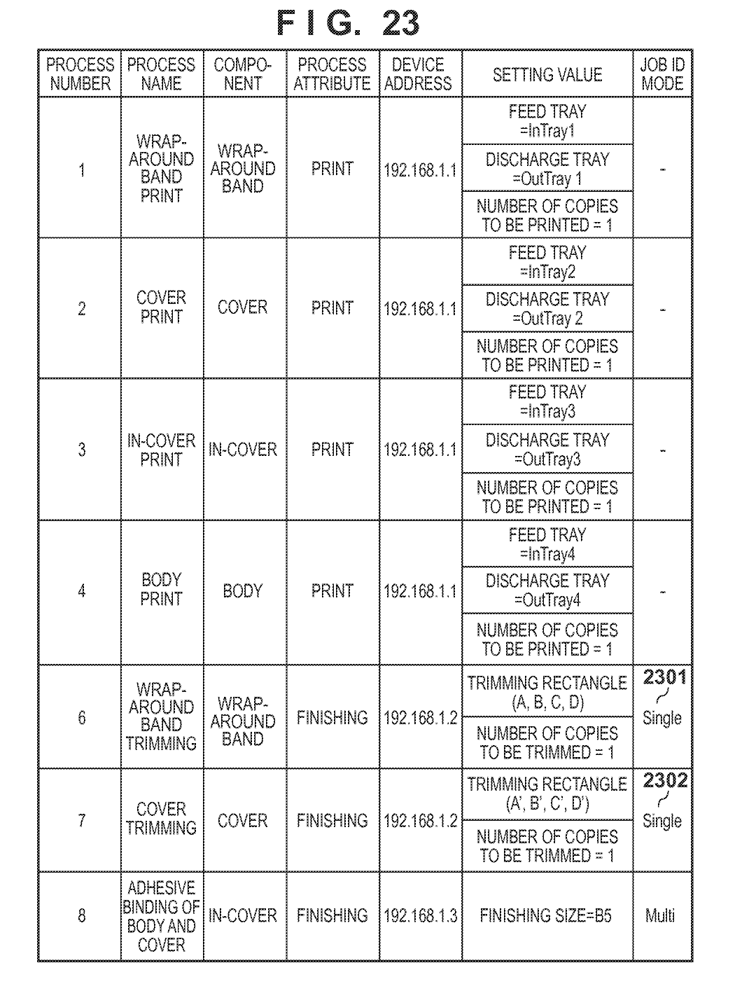

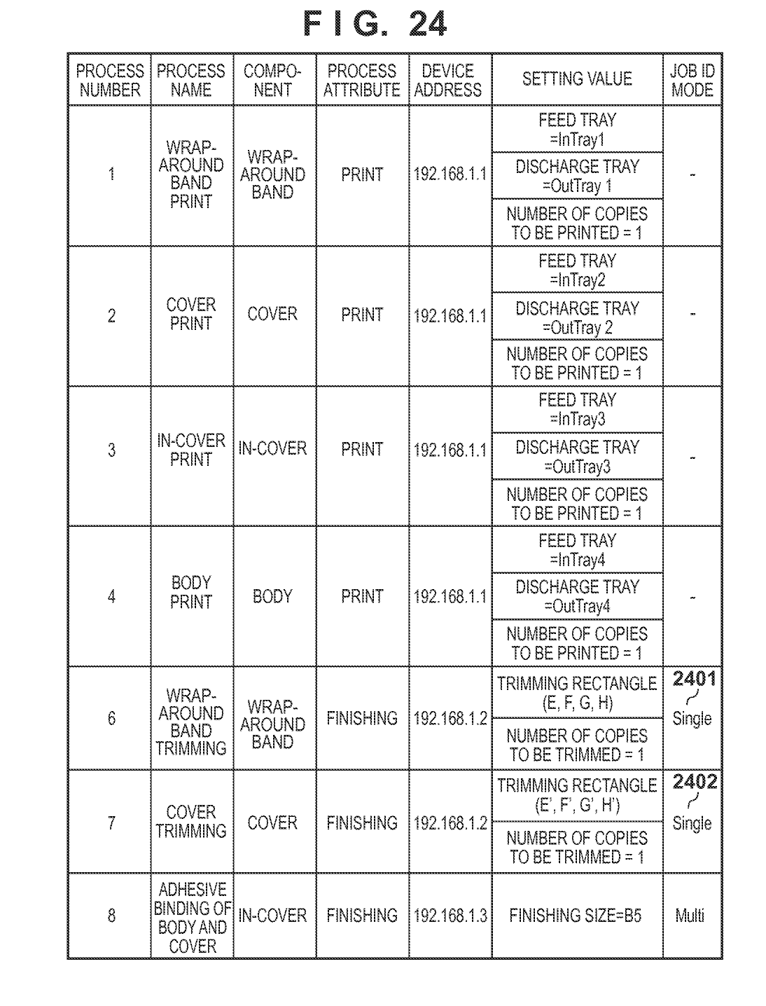

The grouping processing in step S1402 for the respective settings will be described in detail below with reference to the flowchart shown in FIG. 16. FIG. 23 shows an example of job setting files (001-JobSettings.xml and 002-JobSettings.xml) of user data 1 and 2 in this embodiment. FIG. 24 shows an example of a job setting file (003-JobSettings.xml) of user data 3.

Referring to FIG. 23, in a wraparound band trimming process 2301 of user data 1 and 2, a wraparound band trimming rectangle (A, B, C, D) is set.

In a cover trimming process 2302, a cover trimming rectangle (A′, B′, C′, D′) is set. Referring to FIG. 24, in a wraparound band trimming process 2401 of user data 3, a wraparound band trimming rectangle (E, F, G, H) is set. In a cover trimming process 2402, a trimming rectangle (E′, F′, G′, H′) is set. Note that FIGS. 23 and 24 show that the sizes and positions of the wraparound band and the cover trimming rectangles are different in products of users 1 and 2 and user 3.

Also, the feed trays and discharge trays of the respective print processes of user data 1, 2, and 3 are standardized for the respective components, that is, the wraparound band, cover, in-cover, and body. For example, in all of user data 1, 2, and 3, the feed tray of wraparound band data is “InTray1”, and the discharge tray is “OutTray1”.

Furthermore, in a body/in-cover adhesive binding process, all of user data 1, 2, and 3 have the same finishing size=B5, and “in-cover” is set in the component name 903 of the job setting files. That is, the physical job ticket of the adhesive binding process is output together with in-cover print data. Also, the body/in-cover adhesive binding process is set with a job ID mode=“Multi”, and jobs are not integrated if they include a common setting value.

In the flowchart shown in FIG. 16, the job grouping module 403 sequentially selects, as a folder of interest, folders of the finishing processes of interest of the folders 1801 to 1807 of the respective processes (S1601). Note that i in FIG. 16 indicates the process number. A folder of the finishing process can be discriminated by its folder name. For example, the “wraparound band trimming” process folder is selected as a folder of interest first, and then is loaded.

In step S1602, setting values of the finishing process of interest are acquired from all the job setting files in the finishing process folder of interest selected in step S1601. For example, the “wraparound band trimming” process folder is selected as a folder of interest first, and setting values of that folder are acquired. It is checked in step S1603 whether or not all of the acquired setting values of the finishing process assume the same value. If the job setting files have the same setting value, it is checked in step S1604 whether the job ID modes of the process of interest of the corresponding job setting files are the “Single” or “Multi” mode.

If it is determined in step S1604 that all the job ID modes of the process of interest of the job setting files to be compared in step S1603 are “Single” mode, the job setting files of the same setting value are integrated (S1605). The job setting files can be integrated by changing the file name of one job setting file to an integrated name, and deleting the other. Even when setting values other than the process of interest are different, since setting values of different finishing processes are not referred to, no problem is posed. It is checked in step S1606 whether or not the processing is complete for all the finisher processes. If YES in step S1606, this processing ends; otherwise, the next finisher process is selected as a process of interest (S1607), and the process returns to step S1601.

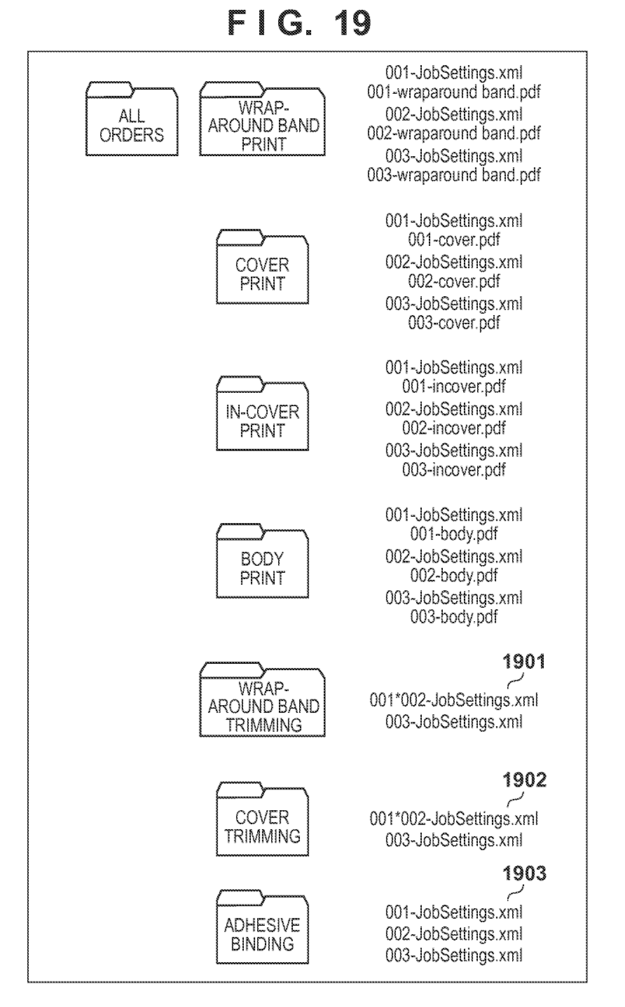

As a result of the processing of the flowchart shown in FIG. 16 for the job configuration shown in FIG. 18, all the job data have the structure shown in FIG. 19. Assume that the name of the job setting file is decided by combining, for example, a character string indicating the job setting file, and a character string unique to each user job. In this case, from the file names of the job setting files before coupling, character strings for the respective user jobs are coupled to define the name of a new job setting file. For example, in FIG. 19, from the files with filenames “001-JobSettings.xml” and “002-JobSettings.xml”, unique character strings “001” and “002” for the respective user jobs are combined to define an integrated file name “001*002-JobSettings.xml”. Note that this integration method is an example, and the job setting files may be integrated by other methods as long as an integrated job setting file allows identifying a plurality of integrated job setting files, and the job setting files before integration.

Referring to FIG. 19, as indicated by a job setting file 1901 of the wraparound band trimming process, the job setting files of users 1 and 2 are integrated into one file (001*002-JobSettings.xml) in the wraparound band trimming process. On the other hand, as indicated by the job setting files 1903 of the adhesive binding process, the job setting files of users 1, 2, and 3 are arranged, and those for the respective user data are used.

In this embodiment, as shown in FIG. 23, since user data 1 and 2 include the same setting values in the finishing processes of process numbers 6 and 7, job setting files are integrated in the respective processes. However, since a job ID mode of process 8 is “Multi”, job setting files are not integrated. As shown in FIG. 24, in user data 3, since the setting values of processes 6 and 7 are different from those of user data 1 and 2, and a job ID mode of process 8 is “Multi”, job setting files are not integrated with those of any user.

In FIG. 19, the name “001*002-JobSettings.xml” of the job setting file 1901 indicates that the job setting files of user data 1 and 2 are integrated in the wraparound band trimming process. The name of a job setting file 1902 indicates that job setting files of user data 1 and 2 are integrated in the cover trimming process. The job setting files 1903 indicate that job setting files of user data 1, 2, and 3 are not integrated in the adhesive binding process.

<Execution of Job>

The sequence for executing jobs of all reconfigured job data, as shown in FIG. 19, will be described below with reference to the flowchart shown in FIG. 17.

In step S1701, the job ticket generation module 404 selects a folder of a process i as a folder of interest from the job data reconfigured for respective processes, as exemplified in FIG. 19. In step S1702, the job ticket generation module 404 loads a job setting file j in the folder of interest selected in step S1701. In this case, i is a process number, j is a serial number assigned to a job setting file (or a number unique to the user, as described above), and their initial values are “1”. If it is determined in step S1703 that the process i of interest selected in step S1701 is the print process, it is judged whether or not a physical job ticket is output. More specifically, it is checked in step S1704 whether or not the finishing process includes the same component as that to be printed in the print process. This processing can be implemented by comparing the component names 903 of job setting files. That is, if a process which has the same process name as that of the process of interest, and includes a process attribute=finishing is found, it can be determined that a corresponding process exists. The corresponding finishing process will be referred to as a related finishing process hereinafter. For example, in a wraparound band print process of a process number 1, a target component name is “wraparound band”, and a process number 6 (wraparound band trimming process) corresponds to a related finishing process.

In step S1705, a physical job ticket associated (linked) with the print data associated with the job setting file j of interest included in the related finishing process folder is specified, and it is checked if that physical job ticket has already been sent. If it is determined in step S1705 that the corresponding physical job ticket has not been sent yet, a physical job ticket template of the related finishing process is loaded in step S1706. For example, in case of the wraparound band print process, the physical job ticket template (shown in FIG. 11) of the related finishing process, that is, the wraparound band trimming process, is loaded.

It is checked in step S1707 whether the job ID mode 907 of the related finishing process is the “Multi” or “Single” mode. If it is determined in step S1707 that the job ID mode is the “Single” mode, a job ID is issued in step S1708. At this time, the job ID to be issued is settled from a job setting file name associated with print data to be printed in the print process of interest (since it is determined in step S1703 that the process of interest is the print process) of job setting files in the related finishing process folder. For example, in the wraparound band trimming process, if the job setting file of interest is “001-JobSettings.xml”, a user unique part “001*002” of the file name of the related job setting file 1901 is issued as a job ID. Such relation can be determined based on the commonality of the user unique part of the file names. For example, if the related finishing process folder includes the job setting file of interest including, in its file name, the same user unique part as that of the job setting file j of interest, that file can be determined as the related job setting file. Even when the job setting files are integrated, as described above, since the file names before integration can be detected, such relation can be determined based on the commonality of the file names before integration.

In step S1709, a thumbnail of a first page of the print data associated with the job setting file of the related finishing process is created. In step S1710, a barcode corresponding to the job ID issued in step S1708 is generated. For example, when the job setting file 1901 shown in FIG. 19 is the corresponding job setting file, thumbnails of the wraparound band print data of users “001” and “002” are to be created. Then, in step S1711, the issued job ID and created thumbnails are laid out on the job ID field of the physical job ticket template loaded in step S1705. As the description of the work explanation field, that described on the template is used intact.

The physical job ticket created in step S1711 and the print data of the print process i of interest are sent to a device (for example, the printer 102) of the address designated by the job setting file and are printed respectively in steps S1716 and S1717. Note that in step S1716, for example, the component name and job ID of the already sent physical job ticket are stored. In step S1705 described above, whether or not the corresponding physical job ticket has already been sent can be determined with reference to the component name and job ID stored in this step. Alternatively, a parameter which indicates whether or not the physical job ticket has already been sent may be assured in association with the process number of the print process, and may be marked to indicate “already sent” for the already sent print process. In this case, step S1705 described above uses that parameter as a criterion.

On the other hand, if it is determined in step S1707 that the job ID mode 907 of the related finishing process is the “Multi” mode, job IDs corresponding to all the job setting files included in the related finishing process folder are issued in step S1712. The job ID to be issued can be a user unique part of the file name of the corresponding job setting file. In step S1713, thumbnails of first pages of all print data associated with the job setting files included in the related finishing process folder are created. In step S1714, the job IDs issued in step S1712 are converted into barcodes. In step S1715, the barcodes as the job IDs and thumbnails are laid out on the physical job ticket template, thus creating a “Multi”-mode physical job ticket. It is desirable to lay out the job IDs and thumbnails, for example, one above the other in a format which allows to visually confirm that they are associated with each other.

If it is determined in step S1703 that the process i of interest is not a print process, that is, it is a folder of a finishing process, a job ID is issued in step S1718. The job ID is issued in the same manner as in step S1708 and the like. That is, at this time, the job ID to be issued is settled from the job setting file name of the finishing process. For example, “001*002” of the file name of the file 1901 in the wraparound band trimming process is issued as a job ID. In step S1719, the job setting file is sent to the near-line finisher having an address designated by the job setting file together with the job ID. The job setting file to be sent is that included in the folder of the process i of interest.

If it is determined in step S1720 that processing is complete for all job setting files in the folder of the process i of interest, the process advances to step S1721. If it is determined in step S1721 that processing is complete for folders of all the processes, the overall processing ends. If it is determined in step S1720 that job setting files to be processed still remain, the next job setting file is selected as the job setting file j of interest. If it is determined in step S1721 that folders of the processes to be processed still remain, the next process is selected as the process i of interest.

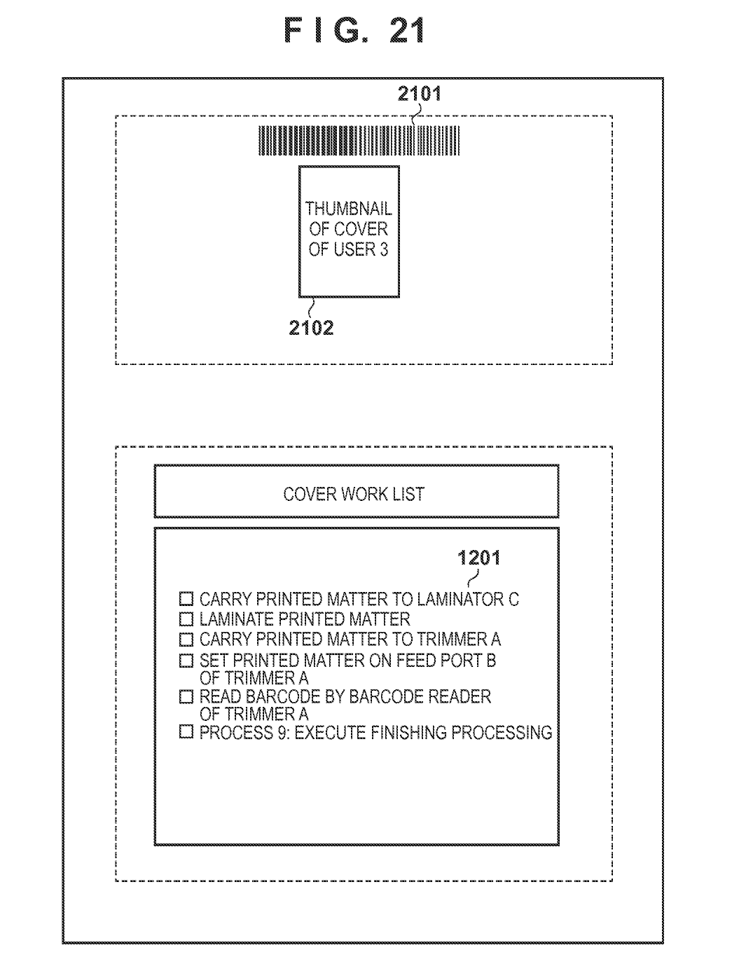

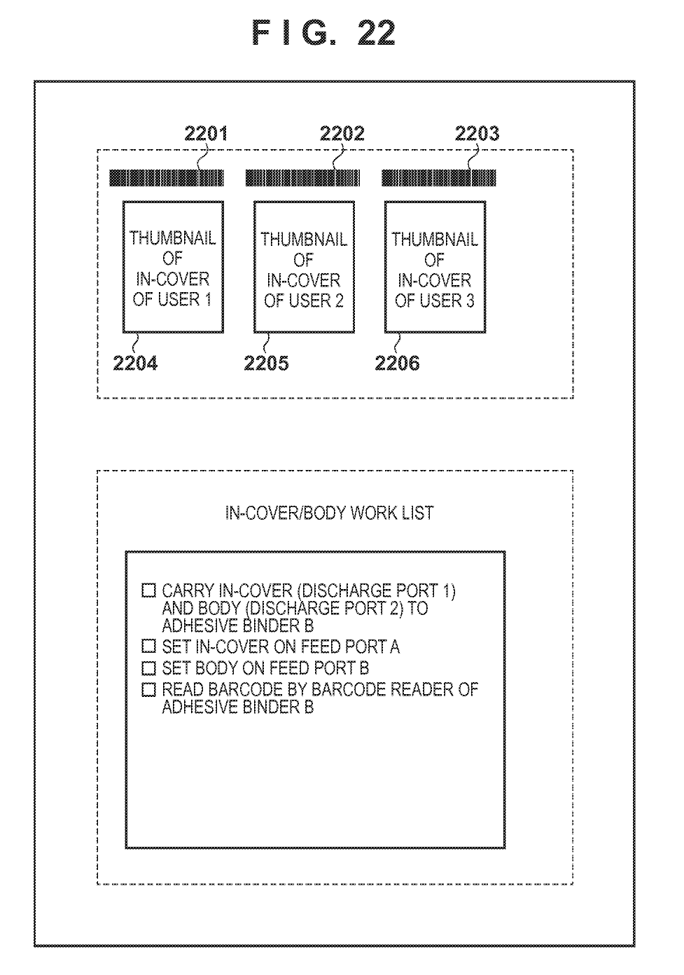

As a result, from the job data shown in FIG. 19, physical job tickets exemplified in FIGS. 21 and 22 can be printed to be continuous with related print data, so that they are output above, for example, printed matters based on the job data.

<Practical Example>

The flowchart shown in FIG. 17 will be described below more practically. When the job data shown in FIG. 19 are to be processed, the wraparound band print folder is selected in step S1701. In step S1702, “001-JobSettings.xml” in the wraparound band print folder is selected. It is determined in step S1703 that this folder is that of the print process. Since the process name 903 of the process number 6 is “wraparound band” and process 6 with the same process name is found in step S1704, the process advances to step S1705. Since a physical job ticket linked with wraparound band print data “001-wraparound band.pdf” has not been sent yet in step S1705, the process advances to step S1706. In step S1706, a wraparound band physical job ticket template (FIG. 11) is selected. Since this process has the “Single” mode in step S1707, the process advances to step S1708. In step S1708, a job ID related to the job setting file of interest of those included in the related finishing process is issued.

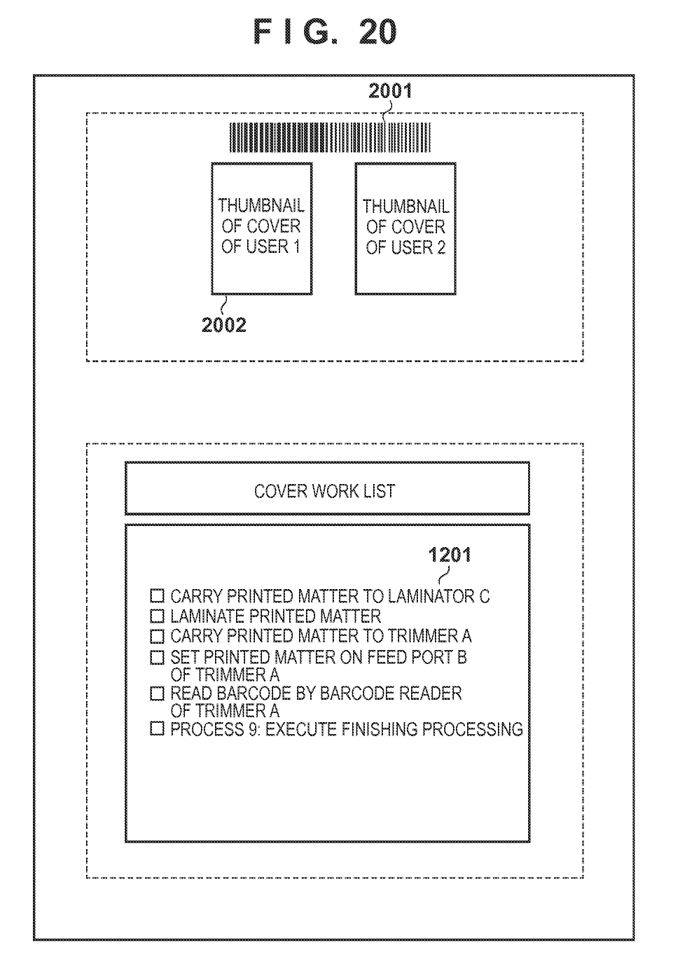

As the job ID to be issued, “001*002” is issued based on the job setting file “001*002-JobSettings.xml” including print data to be printed in the print process of interest in the wraparound band trimming process. In step S1709, thumbnails of print data of users “001” and “002”, that is, “001-wraparound band.pdf” and “002-wraparound band.pdf” associated with this job setting file are created. In step S1710, a barcode of the job ID (001*002) is generated. In step S1711, the barcode and thumbnails are laid out on the template, thus generating physical job ticket data. FIG. 20 shows the physical job ticket generated in step S1711. A barcode 2001 is generated by encoding the job ID (“001*002”). In step S1716, this physical job ticket is printed by the printer 102. In step S1717, the print data “001-wraparound band.pdf” is printed by the printer 102.

The process advances to step S1720. Since processing is not complete for all the job setting files yet, the next job setting file (“002-JobSettings.xml”) is selected in step S1702. It is determined in step S1703 that this folder corresponds to that of the print process, and the process advances to step S1704. Since the process name 903 of the process number 6 is “wraparound band” in step S1704, the process advances to step S1705. Since the physical job ticket associated with the print data “002-wraparound band.pdf” associated with the job setting file “002-JobSettings.xml” has already been sent in the processing at the time of the print data “001-wraparound band.pdf” in step S1705, the process branches to step S1717, and the print data “002-wraparound band.pdf” is printed.

It is then determined in step S1720 that processing is not complete for all the job setting files yet, and a job setting file “003-JobSettings.xml” is loaded in step S1702. It is determined in step S1703 that this folder corresponds to that of the print process, and the process advances to step S1704. Since the process name 903 of the process number 6 is “wraparound band” in step S1704, the process advances to step S1705. Since a physical job ticket linked with wraparound band print data “003-wraparound band.pdf” has not been sent yet in step S1705, the process advances to step S1706. In step S1706, a wraparound band physical job ticket template (FIG. 11) is selected. Since this process has the “Single” mode in step S1707, the process advances to step S1708.

In step S1708, a job ID is issued. As this job ID, “003” is issued based on the job setting file “003-JobSettings.xml” including this print data in the wraparound band trimming process. In step S1709, a thumbnail of a first page of print data associated with “003” associated with this job setting file, that is, “003-wraparound band.pdf”, is created. In step S1710, a barcode of the job ID (003) is generated. In step S1711, physical job ticket data is generated. FIG. 21 shows the physical job ticket generated in step S1711. A barcode 2101 is generated by encoding the job ID (“003”). In step S1716, this physical job ticket is printed by the printer 102. In step S1717, the print data “003-wraparound band.pdf” is printed by the printer 102. Next, the process advances to step S1720, and it is determined that processing is complete for all the job setting files. Then, the process advances to step S1721. Since it is determined in step S1721 that processing is not complete for all the process folders yet, a folder of a cover print process as the next process folder is selected in step S1701.

Since the processing for the cover print process is the same as that of the wraparound band print folder, a description thereof will not be repeated. After the processing of the cover print process, a folder of an in-cover print process is selected.

Processing executed when the in-cover print process is to be processed in FIG. 19 will be described in detail below. If the in-cover print process folder is selected in step S1701, a first job setting file “001-JobSettings.xml” in that folder is loaded. In step S1703, this process is determined as a print process based on the process attribute, and the process advances to step S1704. Since the loaded job setting file (FIG. 23) includes an adhesive binding process (process number 8) having “in-cover” as the component name in step S1704, the process advances to step S1705. It is determined in step S1705 that a physical job ticket linked with in-cover print data has not been sent yet, and a physical job ticket template of a finishing process associated with the in-cover component is loaded in step S1706. FIG. 13 shows this physical job ticket template.

It is determined in step S1707 that the job ID mode is the “Multi” mode, and the process advances to step S1712. In step S1712, job IDs are issued for all the job setting files included in the adhesive binding process. More specifically, job IDs “001”, “002”, and “003” are issued. In step S1713, thumbnails of first pages of all print data associated with the job IDs “001”, “002”, and “003”, that is, “001-incover.pdf”, “002-incover.pdf”, and “003-incover.pdf”, are created. In step S1714, barcodes corresponding to the job IDs “001”, “002”, and “003” are generated. In step S1715, a “Multi”-mode physical job ticket is generated based on the thumbnails of the print data created in step S1713 and the barcodes generated in step S1714. FIG. 22 shows the generated physical job ticket. A barcode 2201 corresponds to the job ID “001”. A barcode 2202 corresponds to the job ID “002”. A barcode 2203 corresponds to the job ID “003”. This physical job ticket is output to the designated address (printer 102) in step S1716. In step S1717, the print data “001-incover.pdf” is output to the designated address (printer 102).

It is determined in step S1720 that processing is not complete for all the job setting files yet, and the next job setting file “002-JobSettings.xml” is loaded in step S1702. The process similarly advances to step S1705. In this step, it is determined that the physical job ticket linked with the print data has already been sent, and the print data “002-incover.pdf” is printed in step S1717. Likewise, the next job setting file “003-JobSettings.xml” is loaded in step S1702. It is determined in step S1705 that the physical job ticket linked with the print data has already been sent, and the print data “003-incover.pdf” is printed in step S1717.

Then, the next body print process is selected. However, as for the body, since no related finishing process is defined, the process branches from step S1704 to step S1717. For all the users, body print data are sent to the designated address (in this case, the printer 102), and are printed, thus ending the processing.

If the wraparound band trimming process folder is selected in step S1701, the job setting file “001*002-JobSettings.xml” is selected in step S1702. It is determined in step S1703 that this process is not a print process, and the process advances to step S1718. In step S1718, a job ID “001*002” as a user unique part of the job setting file is issued. In step S1719, the job ID and the job setting file are sent to the finisher (near-line trimmer) having an address designated by the device address 905.

If it is determined in step S1720 that processing is not complete for all the job setting files yet, the next job setting file “003-JobSettings.xml” is selected in step S1702. Likewise, a job ID “003” is issued in step S1718, and the job ID and job setting file are sent to the finisher (near-line trimmer) having an address designated by the device address 905 in step S1719.

Next, the cover trimming process is processed in the same manner as in the wraparound band trimming process. Finally, the adhesive binding process is processed. In this process, job setting files “001-JobSettings.xml”, “002-JobSettings.xml”, and “003-JobSettings.xml” are sent to the finisher (near-line adhesive binder) having an address designated by the device address 905.

The workflow processing by the information processing apparatus 101 is completed in this way. The remaining works include offline works and those using the near-line finisher and offline finisher. An operator processes respective bundles of printed matters indicated by thumbnails with reference to the physical job ticket shown in FIG. 20 along the work explanations described on the physical job ticket. For example, in the near-line trimmer, after a barcode is read, setting values of finishing processing are read from a job setting file of the read job ID, and the finishing processing is executed according to the read setting values. As described above, since printed matters, processing of which is instructed by a single physical job ticket, are processed using the same settings even by a different user, they can be set on and processed by the finishing apparatus together. By designating the “Multi” mode, independent work instructions can be described on one physical job ticket.

As described above, according to this embodiment, in the bookbinding system which receives an order of a creation request of printed matters from a third party, generates and delivers desired products, pieces of information for the respective orders (jobs) by the respective users are rearranged for the respective processes, and jobs having the same settings in each process are integrated, thereby reducing the number of work instructions to be managed, and improving the work efficiency.

More specifically, by integrating processes having the same settings, as shown in FIG. 20, the number of post-process instructions to be managed can be reduced. Products ordered from a user tend to include the same settings. For example, assuming that 70% of settings are the same, it is confirmed that the work efficiency can be improved by 70% for orders of the same type.

Job IDs are issued for respective user data as in the physical job ticket shown in FIG. 22. In this case, only one physical job ticket to be managed is generated. In this way, the number of post-process instructions to be managed can be reduced, and processing can be individually managed for respective user data. For example, when creation processing of products is to be interrupted, and works are to be restarted, the processing can be individually interrupted and executed. In such case, the work efficiency can be dramatically improved.

Note that the conventional method and that of this embodiment may be configured to be switched according to user's settings in place of unconditionally applying this embodiment. In this case, when the conventional method is selected, physical job tickets are output for each user in association with printed matters of respective print processes.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-273016, filed Dec. 7, 2010, which is hereby incorporated by reference herein in its entirety.

What is claimed is:

1. A job control apparatus, which controls execution of jobs for which a plurality of processes including a print process by a printing apparatus and a finishing process by a finishing apparatus are defined by job setting files, said apparatus comprising:
a grouping unit, configured to group job data of the respective jobs in correspondence with the same processes as processes included in a job to be processed;
an integrating unit, configured to integrate job data of the jobs including common settings in association with a finishing process grouped by said grouping unit; and
a sending unit, configured to send job data of the job to be processed to the printing apparatus or the finishing apparatus which performs the processes for respective processes,
wherein in a case where said sending unit sends job data to the printing apparatus and prints the job data in a print process of an integrated job, said sending unit issues one physical job ticket for one integrated job for finishing processing of that job.

2. The apparatus according to claim 1, wherein the finishing apparatus accepts an input of a job ID, and
said sending unit issues the physical job ticket by sending the physical job ticket which describes a job ID of the integrated job and work instructions in the finishing apparatus to the printing apparatus, and controlling the printing apparatus to print the physical job ticket.

3. The apparatus according to claim 1, further comprising a unit, configured to designate job integration,
wherein only in a case where the job integration is designated, said grouping unit executes grouping, and said integrating unit executes integration.

4. A job control apparatus, which is connected to a printing apparatus and a finishing apparatus, and controls execution of jobs for which a plurality of processes including a print process by the printing apparatus and a finishing process by the finishing apparatus are defined by job setting files, said apparatus comprising:
a grouping unit, configured to form groups of job setting files and print data of the respective jobs in correspondence with the same processes as processes included in a job to be processed;
an integrating unit, configured to integrate job setting files of jobs including common settings of a finishing process in association with a group of the finishing process formed by said grouping unit; and
a sending unit, configured to send job data of the job to be processed to the printing apparatus or the finishing apparatus which performs the processes for respective processes,
wherein in a case where said sending unit sends job data associated with the job setting file integrated by said integrating unit to the printing apparatus in the print process, said sending unit sends one physical job ticket for one integrated job to the printing apparatus together, and controls the printing apparatus to print the physical job ticket.

5. A method of controlling, by a job control apparatus, execution of jobs for which a plurality of processes including a print process by a printing apparatus and a finishing process by a finishing apparatus are defined by job setting files, the method comprising:
grouping job data of respective jobs in correspondence with the same processes as processes included in a job to be processed;
integrating job data of jobs including common settings in association with the grouped finishing process; and
sending job data of the job to be processed to the printing apparatus or the finishing apparatus which performs the processes for respective processes,
wherein in the sending, in a case where job data is sent to and printed by the printing apparatus in the print process of the integrated job, one physical job ticket for one integrated job is issued for finishing processing of that job.

6. A method of controlling, by a job control apparatus connected to a printing apparatus and a finishing apparatus, execution of jobs for which a plurality of processes including a print process by the printing apparatus and a finishing process by the finishing apparatus are defined by job setting files, the method comprising:
forming groups of job setting files and print data of respective jobs in correspondence with the same processes as processes included in a job to be processed;
integrating job setting files of jobs including common settings of the finishing process in association with a formed group of the finishing process; and
sending job data of the job to be processed to the printing apparatus or the finishing apparatus which performs the processes for respective processes,
wherein in the sending, in a case where job data associated with the integrated job setting file is sent to the printing apparatus in the print process, one physical job ticket for one integrated job is sent to and printed by the printing apparatus together.

7. A non-transitory computer-readable storage medium recording a program for controlling a computer to function as a job control apparatus, which controls execution of jobs for which a plurality of processes including a print process by a printing apparatus and a finishing process by a finishing apparatus are defined by job setting files, said job control apparatus comprising:
a grouping unit, configured to group job data of respective jobs in correspondence with the same processes as processes included in a job to be processed;
an integrating unit, configured to integrate job data of jobs including common settings in association with a finishing process grouped by said grouping unit; and
a sending unit, configured to send job data of the job to be processed to the printing apparatus or the finishing apparatus which performs the processes for the respective processes,
wherein in a case where said sending unit sends job data to the printing apparatus and prints the job data in a print process of an integrated job, said sending unit issues one physical job ticket for one integrated job for finishing processing of that job.

8. A non-transitory computer-readable storage medium recording a program for controlling a computer to function as a job control apparatus, which is connected to a printing apparatus and a finishing apparatus, and controls execution of jobs for which a plurality of processes including a print process by the printing apparatus and a finishing process by the finishing apparatus are defined by job setting files, said job control apparatus comprising:
a grouping unit, configured to form groups of job setting files and print data of respective jobs in correspondence with the same processes as processes included in a job to be processed;
an integrating unit, configured to integrate job setting files of jobs including common settings of a finishing process in association with a group of the finishing process formed by said grouping unit; and
a sending unit, configured to send job data of the job to be processed to the printing apparatus or the finishing apparatus which performs the processes for the respective processes,
wherein in a case where said sending unit sends job data associated with the job setting file integrated by said integrating unit to the printing apparatus in the print process, said sending unit sends one physical job ticket for one integrated job to the printing apparatus together, and controls the printing apparatus to print the physical job ticket.
